(19) United States
(12) Patent Application Publication
(10) Pub. No.: US 2016/0050856 A1
(43) Pub. Date: Feb. 25, 2016

(54) VERTICAL GARDEN SYSTEM

(71) Applicant: Kumarpal SHAH, Mumbai (IN)

(72) Inventor: Kumarpal SHAH, Mumbai (IN)

(21) Appl. No.: 14/783,086

(22) PCT Filed: Mar. 25, 2014
(86) PCT No.: PCT/IN2014/000187

§ 371 Date: Oct. 8, 2015

(30) Foreign Application Priority Data
Apr. 11, 2013 (IN) 1357/MUM/2013

(51) Int. Cl. A01G 9/02; A01G 1/00

(52) U.S. Cl. CPC A01G 9/022; A01G 1/001

(57) ABSTRACT

Implementations provide an expandable vertical garden system comprising a frame; drip irrigation pipe(s); drainage pipe(s); a drain tray; and optionally pots or plant containers. The frame of the expandable vertical garden may comprise: holes for inserting screws which get drilled into the support wall/framework; cavities wherein pots can be snapped in and snapped out; a support element in each cavity for the pots to get good anchorage; small holes above each cavity, wherein clips to hold a horizontal irrigation pipe can be fixed in; a large hole at the bottom of the frame for inserting the drain tray; a cavity on a rear side of each frame wherein the drainage pipe can be fixed.

### PRIORITY

This is a National Stage Application under 35 U.S.C. §365 of International Application PCT/IN2014/000187, with an international filing date of Mar. 25, 2014, which claims priority to Indian Patent Application No. 1357/MUM/2013 filed on Apr. 11, 2013. The entire disclosures of International Application PCT/IN2014/000187 and Indian Patent Application No. 1357/MUM/2013 are hereby incorporated herein by reference.

### TECHNICAL FIELD

Implementations relate to a vertical gardening system in modular form. The vertical garden system may be expandable horizontally as well as vertically. The vertical garden system may provide a drainage system wherein water is drained out at specific or regular distance intervals. It may further provide a vertical garden system wherein the water supply per pot can be regulated as per plant requirement. Certain implementations comprise a frame; drip irrigation pipe(s); drainage pipe(s); drain tray; and optionally pots or plant containers.

### BACKGROUND

Nowadays, horizontal open spaces in urban cities are shrinking due to pressure on the land which leaves hardly any scope of greenery. Moreover, with increasing levels of pollution, there is a pressing need for greenery and plants which act as natural air purifiers. Thus, the only solution is Vertical Gardening. There are various ways of installing a Vertical Garden on a given vertical surface. The most common being modules with 16 or 12 cavities and the Geotextile/Polyamide Felt anchorage systems.

In most vertical garden systems, the water from one module drains into the lower modules and so on so forth. Thus the lowest module gets the water from all the above modules and thus there is high probability of plants getting damaged and rotting due to high water saturation.

In the vertical garden systems of the prior art, the water supply is for a zone of plants and not an individual plant. Every plant has different requirements of water for healthy growth. In most vertical garden systems, there are drippers on the irrigation lines which feed more than one plant in a module or given zone. Thus one cannot regulate the water supply to each and every plant individually. Hence there is a need in the art for a vertical garden system wherein each individual plant is watered independently thereby a combination of plants (of different water requirements) can be grown giving the user the freedom to create planting designs as per their imagination. Accordingly there is a need to provide a vertical garden system which addresses the issue of water saturation and which provides desired and regulated water supply to each and every plant.

In the vertical garden systems available, there is no integrated drainage system where the water can be arrested at regular intervals and drained out independently. Thus the water flowing from top to down due to gravity, causes a saturation in the lower zones and the plants tend to die due to overwatering in those areas; their roots decay and the infection can spread to the entire living wall making all the plants unhealthy. A vertical garden system wherein drain water can be collected at various intervals and thereby the saturation factor due to excess water collection can be eliminated.

In the vertical garden systems available, it is not possible to individually remove a plant from the zone to replace it. The replacement may be for mortality change or just design change. In certain implementations, the replacement/removal of plants is made very easy as any individual plant can be removed and replaced with the new desired one.

Implementations of the vertical garden system may address these issues. Certain implementations provide a modular vertical garden system which can expand horizontally as well as vertically. By employing certain implementations of the vertical garden system it is possible to create enchanting patterns, using wide range of choice plants, herbs, medicinal plants, vegetables, fruits, flowers etc. depending on the light conditions available at the site. Certain implementations of the vertical garden system avoid water saturation and provide regulated water supply to each and every plant.

### SUMMARY

An implementation provides an expandable vertical garden system comprising: [a] frame; [b] drip irrigation pipe(s); [c] drainage pipe(s); [d] drain tray; and optionally [e] pots or plant containers.

Another implementation provides an expandable vertical garden system wherein the frame comprises: [a] holes (1) for inserting screws which get drilled into the support wall/framework; [b] cavity (2) wherein pots can be snapped in and snapped out; [c] support element (3) in each cavity for the pots to get good anchorage; [d] small holes (4) above each cavity, wherein the clip to hold horizontal irrigation pipe can be fixed in; [e] a large hole (5) at the bottom of the frame for inserting the drain tray (7); [f] a cavity on rear side of each frame wherein the drainage pipe (6) can be fixed.

Another implementation provides an expandable vertical garden system wherein the drainage pipe (6) is connected to the drain tray (7) using a joint connector (8).

Another implementation provides an expandable vertical garden system wherein the joint connector is a “T” or “L” shaped joint connector.

Another implementation provides an expandable vertical garden system wherein the drain tray (7) is fixed after every third cavity.

Another implementation provides an expandable vertical garden system wherein the frame contains side vertical supports wherein clips can be fixed to support the vertical irrigation pipe.

Another implementation provides an expandable vertical garden system wherein the frame can be fixed side by side and/or one on top of the other.

Another implementation provides an expandable vertical garden system wherein the system further contains drip irrigation line(s) (9).

Another implementation provides an expandable vertical garden system wherein each pot or plant container is drip irrigated by drippers fixed on the drip irrigation line (9) thereby regulating the supply of water per pot.

Another implementation provides an expandable vertical garden system wherein the irrigation line can be regulated by an Automated and/or Manual system.

Another implementation provides an expandable vertical garden system wherein the frame contains: [a] four holes (1) for inserting screws which get drilled into the support wall/framework; [b] three large cavities (2) wherein the pots or plant containers can be snapped in and snapped out; [c] four support elements (3) in each cavity for the pots to get anchorage; [d] two small holes (4) wherein the clip to hold the horizontal irrigation pipe can be fixed in; [e] a large hole (5) for inserting the drain tray (7).

In another implementation, the expandable vertical garden system is expandable vertically and/or horizontally.

Another implementation provides a method of plantation comprising the vertical garden system disclosed herein.

### BRIEF DESCRIPTION OF THE DRAWINGS

The vertical garden system is described hereinafter, and with reference to the accompanying illustrative figures. It must however, be appreciated that the same constructional features described herein can be replicated with minor modification in other garden systems.

FIG. 1 is a view of a frame of the vertical garden system showing: [a] holes (1) for inserting screws; [b] cavity (2) for fitting pots; [c] support element (3); [d] holes (4) above each cavity, for holding and fixing horizontal irrigation pipe; [e] large hole (5).

FIG. 2 is a view of a vertical garden system with drainage (front view): Frame of the vertical garden system described in FIG. 1 showing drainage pipe (6) connected to the front drain tray (7) using a joint connector (8). The figure also shows horizontal drip irrigation pipes(s)/line(s) (9).

FIG. 3 is a view of a vertical garden system with drainage (side view).

FIG. 4(A) is a magnified view of a vertical garden system with drainage (side view).

FIG. 4(B) is a magnified view of a drain tray (7) connected to the frame.

FIG. 5(A) shows irrigation lines along with clips; drainage pipe; and pot or plant container (aerial view).

FIG. 5(B) shows views of a drain tray; drain pipe and joint connector.

FIG. 6(A) shows views of pot/plant containers.

FIG. 6(B) shows views of a drain tray.

FIG. 6(C) shows clips for attaching and holding drip irrigation pipe.

FIG. 7 shows views of frames of vertical garden system fixed to the wall to create a green living wall.

FIG. 8(A) shows a view of the fixing of bituminous sheet on wall.

FIG. 8(B) shows a view of fixing a drainage pipe on waterproofed surface.

FIG. 9(A) shows the fixing of frames followed by fixing clips with irrigation pipe(s).

FIG. 9(B) shows the fixing of a drain tray to the frame of vertical garden system.

FIG. 10(A) shows the fixing of pots onto the frame of vertical garden system.

FIG. 10(B) shows a vertical garden system with drip irrigation pipes, pots/plant containers, drain tray and drain pipes.

### DETAILED DESCRIPTION

Variations and modifications are possible without departing from the essential inventive concept embodied herein. The specific constructional detail described herein is not limiting and is intended to provide teaching to one skilled in the art to employ the vertical garden system which is used for a similar function.

The modular vertical garden system may use about 4 to 8 inches wide strip of open space where the system can be fixed and installed. The frame of the vertical garden system can be prepared using environmentally friendly material like polyolefin, polypropylene, polypropylene co-polymer, polyvinyl chloride, high density polyethylene, re-cycled polypropylene or any other equivalent thereof preferably re-cycled polypropylene.

The vertical garden system has been designed to facilitate easy wall fixing. The vertical garden system may comprise: (a) frame; (b) drip irrigation pipe(s); (c) drain pipe(s); (d) drain tray; and optionally (e) pots or plant containers.

The frame comprises: [a] holes (1) for inserting screws which get drilled into the support wall/framework; [b] cavity (2) wherein pots can be snapped in and snapped out; [c] support element (3) in each cavity for the pots to get good anchorage; [d] small holes (4) above each cavity, wherein the clip to hold horizontal irrigation pipe can be fixed in; [e] a large hole (5) at the bottom of the frame for inserting the drain tray (7); [f] a cavity on rear side of each frame wherein the drainage pipe (6) can be fixed.

The frame of the vertical garden system may optionally contain side vertical supports of the frame where clips can be fixed to support the vertical irrigation pipe wherever needed.

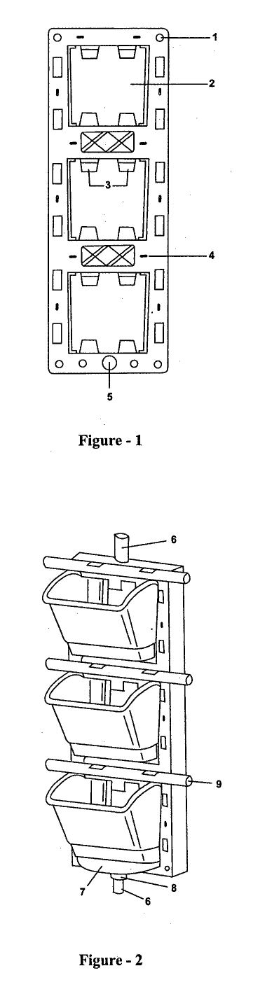

In a preferable embodiment (FIG. 1) the frame may contain: (a) four holes (1) to insert screws which then get drilled into the support wall/framework; (b) three large cavities where the pots or plant containers can be snapped in & snapped out smoothly; (c) four support elements (3) in each cavity for the pots to get good anchorage; (d) two small holes (4) where the clip to hold the horizontal irrigation pipe can be fixed in; (e) a large hole (5) from where the drain tray (7) can be inserted. Thus for every three pots or plant containers there is one drain tray.

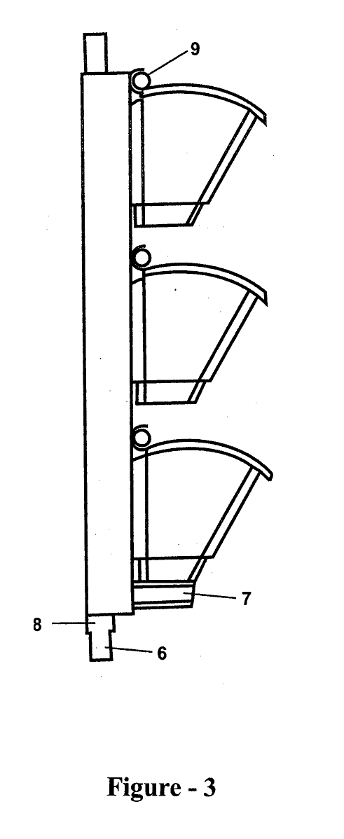

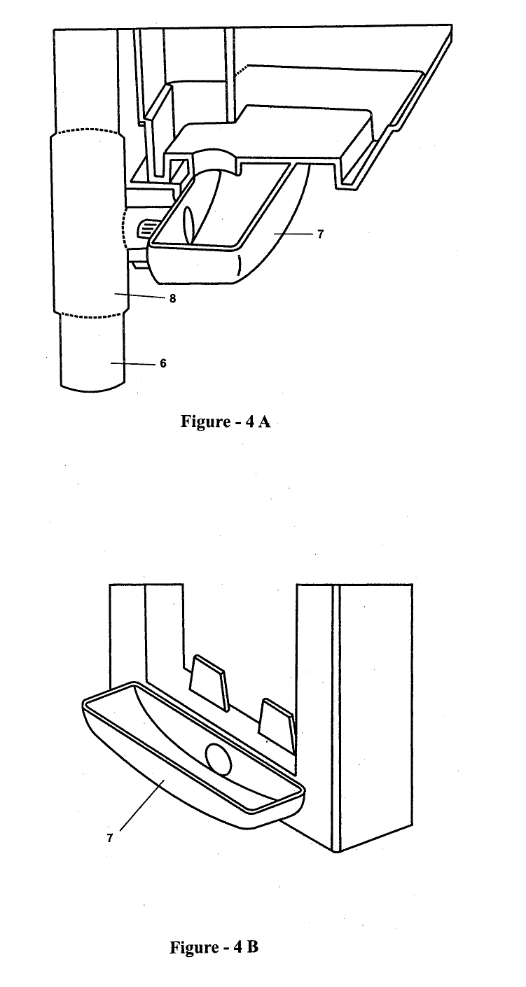

The frame may support a pot or plant container with growing media and plants weighing up to 1000 gms each gets good support and anchorage so that it does not eject out easily. On the rear side of each frame there is a cavity where the drainpipe can be fixed and thus the drain pipe is not visible. The drainage pipe (6) is connected to the front drain tray (7) using a joint connector (8) preferably a “I” or “L” shaped joint connector (FIGS. 2 and 3).

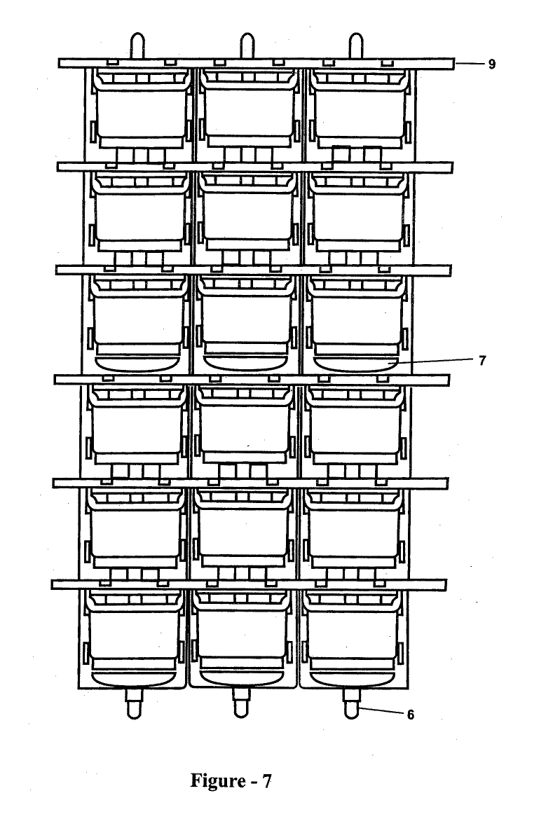

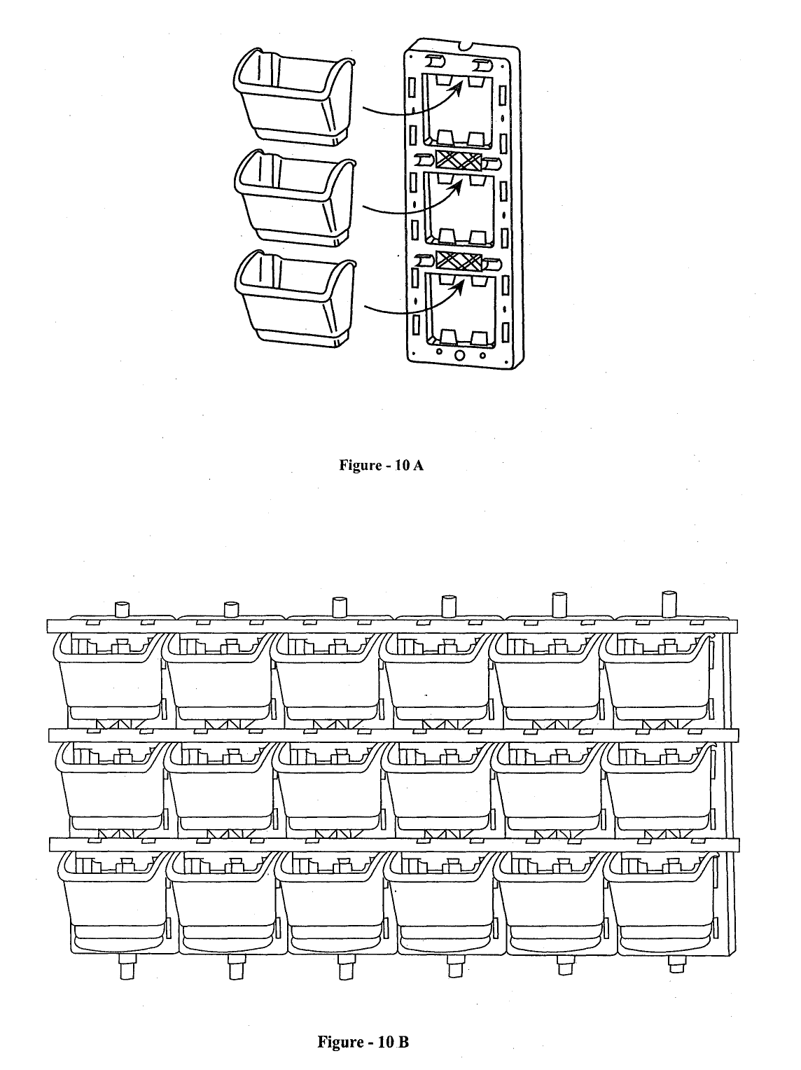

The frames can be fixed side by side and one on top of another so as to cover the entire wall which requires to be made into a vertical garden [FIGS. 7 and 10(B)].

The vertical garden system disclosed herein can be employed for method of plantation.

Drainage System:

One of the special features of certain implementations is the vertical garden system of its drainage system. The vertical garden system may have a drain tray (7) fixed after every third cavity. Thus the water is arrested and drained out at every specific interval and thus there is no plant mortality due to water saturation.

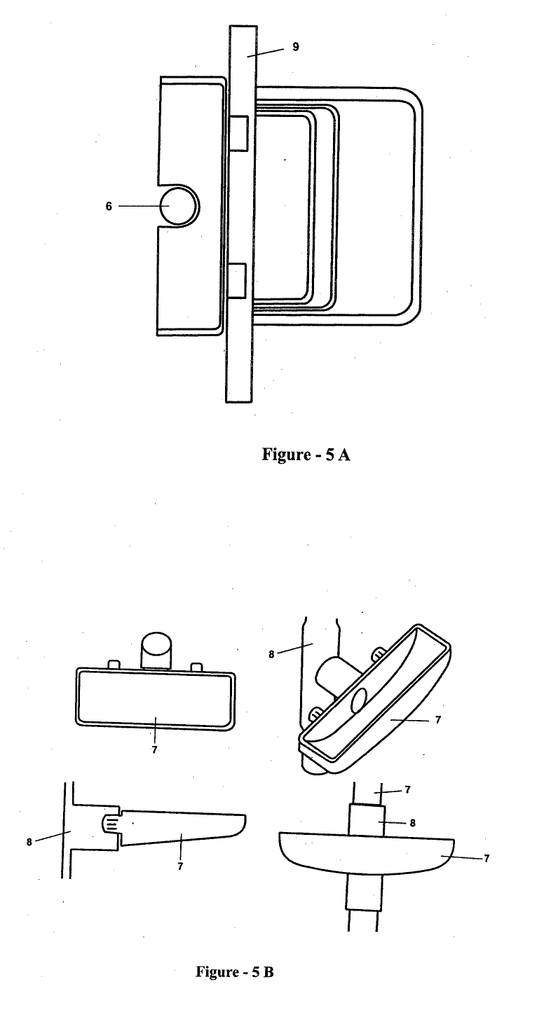

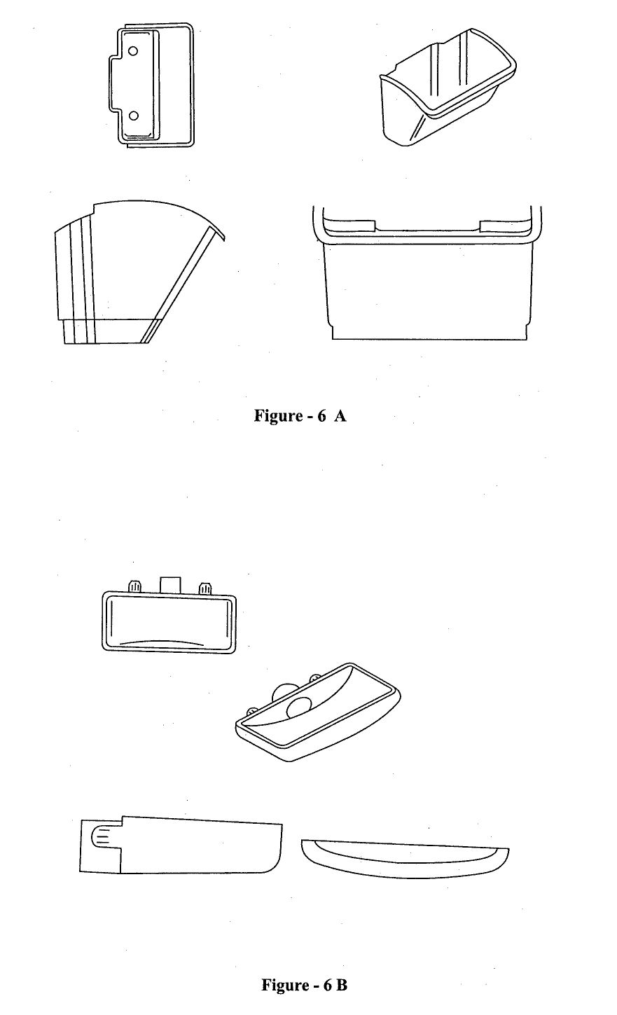

The working of the drainage (FIGS. 4 and 5) involves:

(A) at the bottom of each frame, there is a large hole from where the drain tray can be inserted. Thus for example after every specific interval pots, there is one drain tray. (B) On the rear side, each frame has a cavity where the drainpipe (6) can be fixed and thus the drain pipe is not visible. The drainpipe (6) is then connected to the front drain tray (7) using joint connector (8) preferably a “T” joiner. (C) One end of the joiner connects the corresponding frames drain tray (7), the other end to its rear drain pipe and the last end connects to the drain pipe of the next

Irrigation System:

Another special feature of certain implementations is the irrigation system. Pot or plant containers may have a corresponding dripper and thus the water supply per pot can be regulated as per the plant requirement. One can fix a 1LPH/2LPH/3LPH/4LPH or more capacity dripper on the horizontal irrigation line.

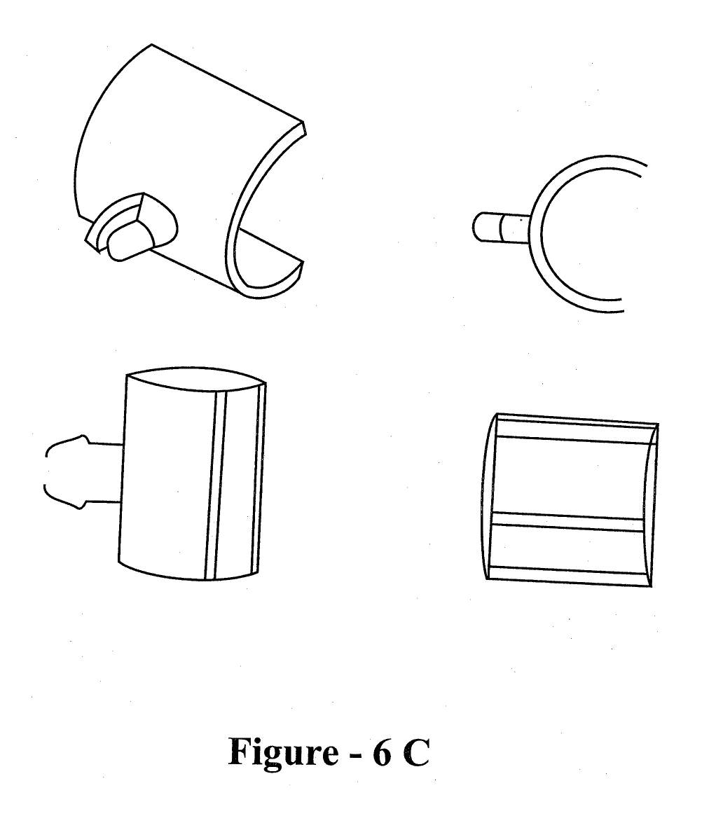

Above each cavity, there are small holes preferably two where the clip to hold the horizontal irrigation pipe can be fixed in. There are additional small side vertical supports preferably six of the frame where clips can be fixed to support the vertical irrigation pipe wherever needed (FIG. 6).

The irrigation system can then be connected to the main water supply line. The working of the irrigation system can be regulated using an Automated or Manual system depending upon the client's requirement/site conditions.

A fertilizer tank/ventury can also be fixed to the irrigation system for automated fertilizer dispensing.

Installation of the vertical garden system:

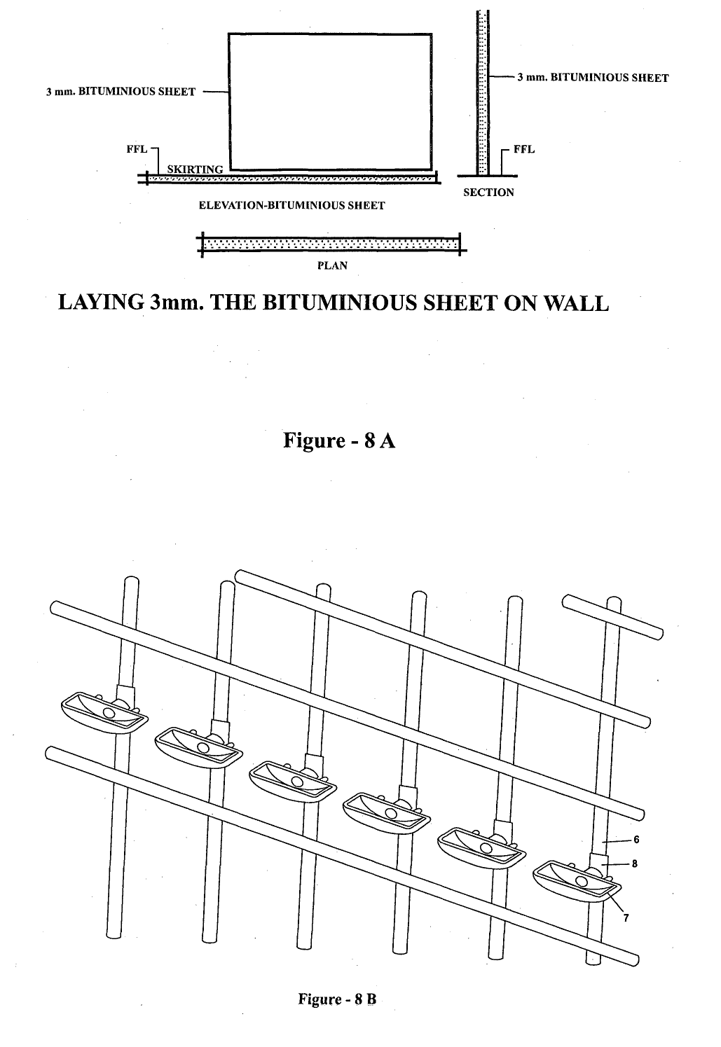

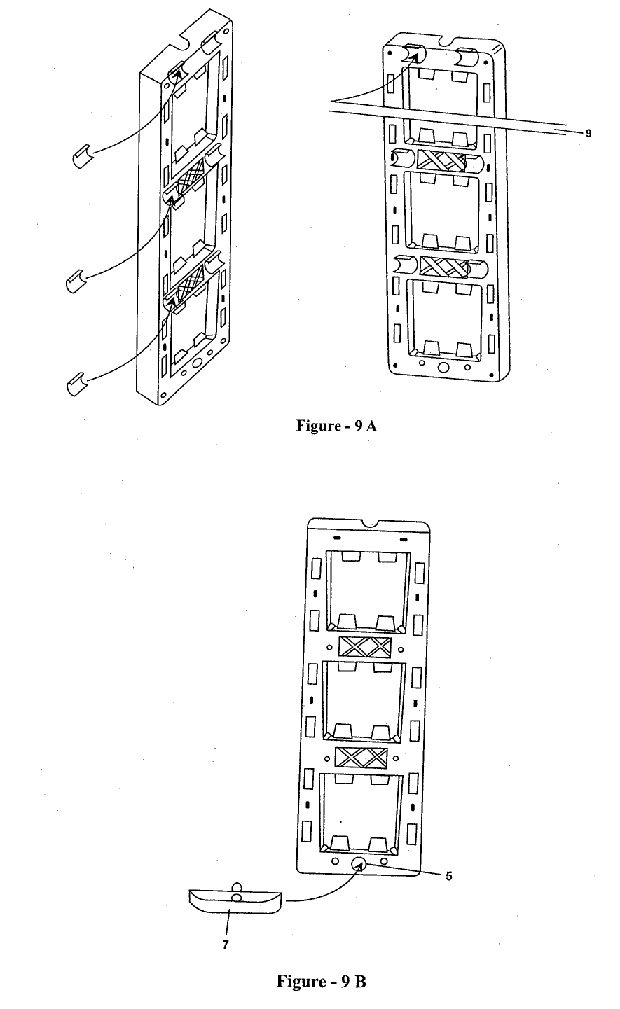

The vertical garden system can be installed on any smooth wall (FIGS. 8 and 9). If there is a free standing framework for example a metal framework, a MR grade plywood or any other equivalent material can be fixed to have the smooth surface. On the smooth surface of the wall, plywood, or any other material any bituminous sheet such as industrial bitumen, paving bitumen, crumb rubber modified bitumen (CRMB), polymer modified bitumen (PMB), bitumen emulsion or materials like Hessian felt, joint piller board, primer etc. shall be fixed for waterproofing the same. Drainage Pipes shall be fixed with glue tapes. Vertical garden system frames shall be fixed above these.

### EXAMPLE

On the smooth surface of the wall/plywood, Bituminous sheet is fixed for waterproofing the same. Drainage pipes are fixed with glue tapes. Vertical garden system frames are fixed above these. A 16 mm drip lateral followed by drippers (Each dripper is dedicated for per pot) is fixed on these frames. These drip lines and drain lines are connected to the main lines. After this, the planted pots are installed on the frames.

It is possible to create most enchanting patterns with the vertical gardening system using wide range of your choice plants, herbs, flowers, fruits, medicinal plants and vegetables depending on the light conditions available at your site.

Due to its modular design it is possible to make any design by extending the vertical garden system frame both vertically & horizontally, it is possible to create circular tower, stand-alone square column or rectangular shapes, as far as your space and imagination can facilitate.

The pots can be easily snapped-in or snapped-out onto the vertical garden system frame, thus providing convenience of installation and change whenever needed.

Drain pipes are preferably not seen once the system is fully installed thus the system is aesthetically advantageous.

Stop Contamination: The water borne contaminations usually spread from one pot to the other due to the water flowing from one pot to the other. In certain implementations of the vertical garden system, drain trays are placed at regular intervals and thus reduce the chances of plant contamination of this sort.

Irrigation: the vertical garden system may have provision to easily fix drip lines to irrigate every individual plant pot.

Drain trays are placed at specific intervals: These trays are uniquely shaped and sloped at the base to drain out all the dripped water from the pots above. Thus, plant mortality due to over watering and saturation is minimized.

Pots: Different sizes for different plant types. Independent planter makes diverse plant varieties to grow unlike other green wall modular systems where you cannot monitor the water requirement. Certain implementations provide easy to replace individual pots/plant containers. Change in planting pattern is made easy. The plant pots can be readied at the nursery and installed at the site.

1. An expandable vertical garden system comprising:
a frame;
a drip irrigation pipe;
a drainage pipe;
a drain tray;
a pot or plant container; wherein said frame comprises:
holes for inserting screws which get drilled into a support wall/frame work;
a cavity wherein the pot can be snapped in and snapped out;
support elements in the cavity for the pot to get good anchorage; small holes above the cavity, wherein a clip to hold a horizontal irrigation pipe can be fixed in;
a large hole at a bottom of the frame for inserting the drain tray;
a second cavity on a rear side of the frame wherein the drainage pipe can be fixed.

2. The expandable vertical garden system of claim 1 wherein the drainage pipe is connected to the drain tray using a joint connector.

3. The expandable vertical garden system of claim 2 wherein said joint connector is a “T” or “L” shaped joint connector.

4. The expandable vertical garden system of claim 1 wherein the drain tray is fixed after every third cavity.

5. The expandable vertical garden system of claim 1 wherein the frame contains side vertical supports wherein a clip can be fixed to support a vertical irrigation pipe.

6. The expandable vertical garden system of claim 1 wherein the frame can be fixed side by side and/or one on top of the other.

7. The expandable vertical garden system of claim 1 further containing a drip irrigation line.

8. The expandable vertical garden system of claim 1 wherein each pot or plant container is drip irrigated by a dripper fixed on a drip irrigation line thereby regulating a supply of water per pot.

9. The An expandable vertical garden system of claim 7 wherein the drip irrigation line can be regulated by an Automated and/or Manual system.

10. The expandable vertical garden system of claim 1 wherein the frame contains:
four holes for inserting screws which get drilled into the support wall/framework;
three large cavities wherein the pot or plant container can be snapped in and snapped out;
four support elements in each cavity for the pot to get anchorage; two small holes wherein the clip to hold the horizontal irrigation pipe can be fixed in;
a large hole for inserting the drain tray;
a cavity on the rear side of the frame wherein the drainage pipe can be fixed.

11. The expandable vertical garden system of claim 1 wherein the system is expandable vertically and/or horizontally.

12. A method of plantation comprising the vertical garden system of claim 1.
